(19) United States
(12) Patent Application Publication
(10) Pub. No.: US 2003/0088665 A1
(43) Pub. Date: May 8, 2003

(54) Presentation of network traffic as message sequence charts in network analyzers

(76) Inventor: Juergen Sauermann, Berkeley, CA (US)

Correspondence Address: DR. JUERGEN SAUERMANN, WILDBACHER MUEHLE 59, AACHEN, D-52074, DE

(21) Appl. No.: 09/985,266

(22) Filed: Nov. 2, 2001

(51) Int. Cl. G06F 15/173

(52) U.S. Cl. 709/224; 345/736

(57) ABSTRACT

Methods for displaying (visualizing) messages (data packets or signals) that have been captured by a network analyzer or a captruring program. The messages are displayed similar to the message sequence chart used in standardization documents. The methods use graphical elements (arrows) to represent messages rather than lines of text as in present network analyzers. The methods also visualize relations inside a single network entity and between different network entities.

### FIELD OF INVENTION

The present invention relates to the presentation of signalling messages that are captured by a network analyzer in a graphical user interface to the (human) user of the network analyzer.

### BACKGROUND OF INVENTION

A signal is a sequence of information elements sent from one entity to one or more other entities. A packet is also a sequence of information elements sent from one entity to one or more other entities. The term signal is more common in the circuit switched world of telecommunications, while the term packet is more common in the world of packet switched telecommunications. Packets typically contain more bits of information than signals. In the following, the term messages will be used for both signals and packets. An entity is the abstraction of anything that can send or receive messages, such as computers, a process running on a computer, an interface, et cetera. The exchange of messages between entities is the fundamental principle that controls the operation of both circuit switched networks and packet switched networks. Consequently, the understanding of the messages being exchanged between entities is crucial for the validation and troubleshooting of the hardware and software that comprise all networking equipment.

A network analyzer is an equipment or program that is used to record (capture), store, and visualize messages transmitted over a data link or data network. Network analyzers provide different views with different levels of detail on the stored messages, notably (1) statistical views that focus on the mere counts of certain messages and neglect the timing relations between messages, (2) message sequence views that focus on timing relations between messages and (3) detail views that show the full content of single messages. The more detailed a view is, the less messages it can display simultaneously.

The invention primarily focuses on improving message sequence views, although it is applicable to statistical views as well, thereby loosing some of its benefits due to the loss of timing relations.

### SUMMARY OF INVENTION

This invention proposes to display (visualize) sequences of messages recorded by a network analyzer or capturing program as message sequence charts. This new way of visualizing messages differs significantly from how this is done today.

Today the timing relation between different messages is (usually) shown along the vertical direction of the display, while the sending and receiving entities are shown in a textual representation (if at all). The new way of visualizing messages proposed by this invention visualizes the sending and receiving entities graphically instead.

By using the invention, the time required to comprehend message sequences is significantly reduced, thereby making testing or troubleshooting of data networks more efficient.

### PRIOR ART

Message Sequence Charts

A message sequence chart is a diagram consisting of vertical lines representing certain entities such as network nodes, interfaces or processes and more or less horizontal arrows representing messages sent from one of the entities to one (unicast) or several (multicast or broadcast) other entities. The vertical lines extend over the whole diagram, while the arrows are drawn between the sending and receiving entities. The vertical direction indicates the timely relation between different messages; if a message is shown above another messages then this message is sent earlier than the other message. The vertical lines are labelled as to identify the entity represented by the vertical line (e.g. the type of node or the network address of the entity). The arrows representing the messages are labelled as to identify the nature of the message (e.g. the protocol family of a message). Due to the wide field of possible entities and messages, the actual labelling may vary considerably. FIGS. 1 and 2 show simple examples of message charts, differing in the style how arrows are displayed (horizontally respectively nearly horizontally). The nearly horizontal format is used to indicate “immediate” reactions to messages, but information if a message is an immediate response to another message is hardly available in the context of this invention.

Message sequence charts are frequently used in the standardization of protocols.

Network Analyzers

A network analyzer is an equipment or program that allows to record (capture) messages that are sent over a data link or data network and to visualize the messages recorded. The visualization may be performed on-line (while the messages are recorded) or off-line (after the messages have been recorded). From a users point of view, on-line recording is usually preferred.

A network analyzer usually consists of the following functions. (1) A device for attaching the network analyzer to the data link or data network and recording them (probe). (2) A memory to store either the whole message, or at least part of it, if the message is long. (3) A (capture) filter between the probe and the memory so that only messages of interest occupy memory. (4) A display for visualizing the messages stored in memory. The display is usually organized in such a way that only the message type of several consecutive messages is showed. but the content of particular messages can be viewed in a separate window or area of the display as the user selects a message, e.g. by moving a mouse cursor onto the message and pressing a mouse key. In the context of this invention, a display might also be a printer. (5) A (display-) filter between the memory and the display so that only messages of interest are displayed. The difference between the capture filter (3) and the display filter (5) is that by changing display filter the user can change his or her own view of the stored messages, while messages discarded by a capture filter can not be retrieved by the user when changing the filter.

The invention focuses mainly on (4), that is, on the way message sequences are displayed.

Capturing Programs

For certain data links (such as serial lines) and networks (such as Ethernet based local area networks), all the functions of a network analyzer can be implemented on a general purpose computer such as a personal computer (PC). A serial line probe would be wires connected to the serial port of the PC, while an Ethernet probe would be an network interface card (NIC) of the PC which is run in the so-called “promiscuous mode”, that is it receives all Ethernet packets as opposed to only those addressed to that NIC. The memory of the PC would be used to store the messages. The filters would be implemented in software and the display of the PC would be used to visualize the messages. As the computing power of PCs increases, capturing programs are becoming more and more common compared to specialized network analyzers.

Today there are basically two kinds of such capturing programs. The first kind is purely text based. An example of a text based output is shown in FIG. 3. For text based capturing programs, the filters are specified at the command line or through configuration files, and the output of the program is text in a certain format. The other kind of capturing programs is using a graphical user interface for visualizing the stored messages and for specifying filters. Graphical capturing programs provide for visualizing the stored messages at about the same detail level as the text based version. See FIG. 4 for an example of the visualization of stored messages in a graphical capture program. Graphical capturing programs also provide means of viewing larger parts of messages in a separate window or a separate area on the display. This more detailed view of a single message is typically in a decoded format rather than a sequence of bytes which allows the user to understand the content of the message more easily.

Both the text based and the graphical capturing program, as well as network analyzers have in common, that the stored messages are displayed as lines of text (which are scrollable for the graphical variant), one or several lines per message.

For the purpose of this invention, there is no difference between network analyzers and capturing programs. In the following the term network analyzer shall include capturing programs.

### BRIEF DESCRIPTION OF DRAWINGS

FIG. 1 shows a message sequence chart using horizontal arrows to show messages. A total of 4 network entities (vertical lines) and 6 messages is shown.

FIG. 2 shows the same message sequence as FIG. 1, using nearly horizontal arrows rather than horizontal to show messages. A total of 4 network entities and 6 messages is shown.

FIG. 3 shows the textual output of the prominent capturing program “tcpdump”.

FIG. 4 shows the same output as FIG. 3, but in a graphical user interface.

FIG. 5 shows the same message sequence as FIGS. 3 and 4, but using the invention rather than textual output.

FIG. 6 shows a detail of the invention concerning multicast messages (messages sent to more than one receiver).

FIG. 7 shows a detail of the invention regarding how simple entities could be displayed.

FIG. 8 shows a detail of the invention regarding how more complex entities such as an interface with a single MAC address and two IP addresses could be displayed.

FIG. 9 shows a detail of the invention regarding how even more complex entities such as an interface with a single MAC address and two IP addresses and several ports per IP address could be displayed.

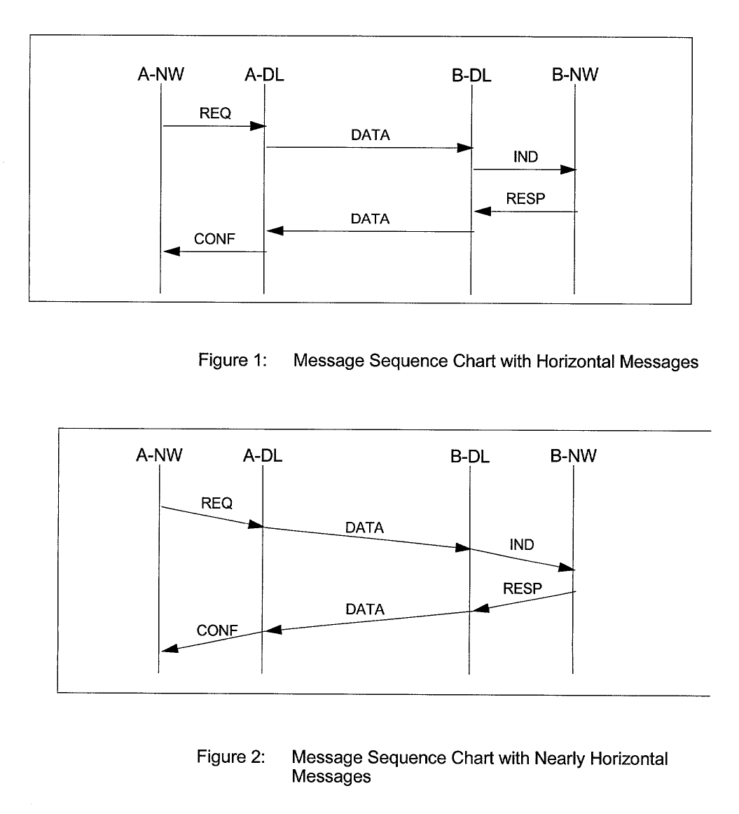

### DETAILED DESCRIPTION

Network analyzers are usually used for two purposes: (1) for troubleshooting, that is for figuring out why a particular data link, network, protocol, or application is not working as expected. This includes interworking tests, where equipment from different vendors using the same protocols is tested together, (2) for validation, that is to prove that an implementation of a protocol is conforming to its specification (which possibly refers to a message sequence chart. If the number of entities involved in a recording of messages is small, then a line by line presentation of messages is appropriate. In contrast, if the number of items is large, such as recordings of messages on a local area network, then a line by line presentation of messages becomes awkward and the time to understand a particular recording becomes infeasible. Filters may help to some extend, but the specification of the filter conditions is less than easy an there is a risk that the cause of a problem (for instance a broadcast message) is filtered out by an inappropriately configured filter.

This invention proposes to avoid the problems of line by line presentations of stored messages by presenting the messages as a message sequence chart instead of a (possibly scrollable) list of text lines. This is generally requires a graphic based display, although a purely text base system is imaginable.

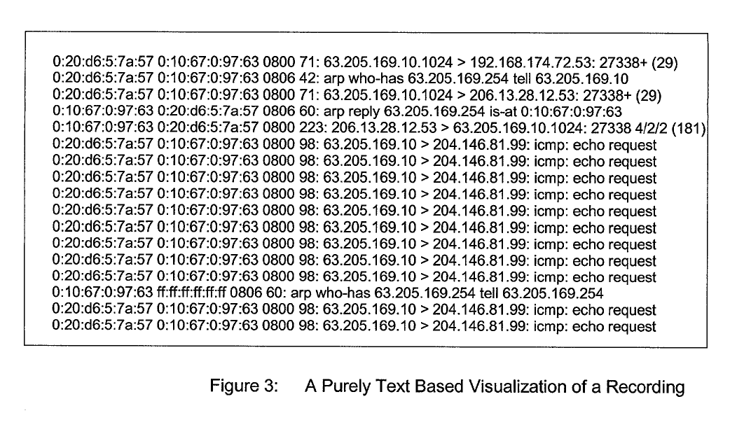

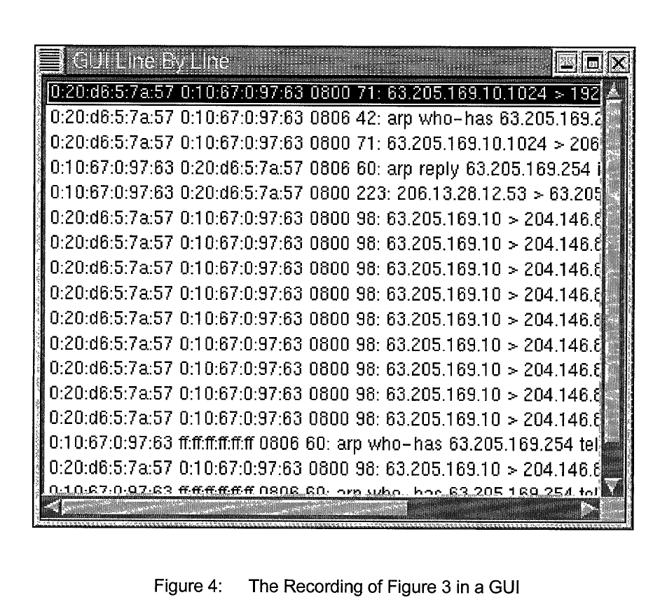

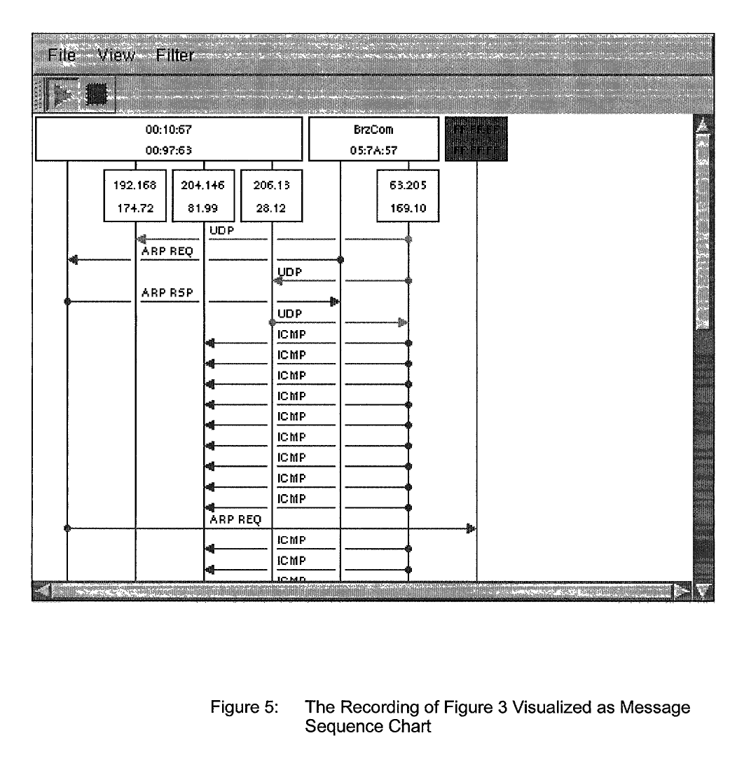

The advantage provided by this invention becomes obvious comparing the present way of visualizing message sequences (FIGS. 3, 4) with the way proposed by this invention (FIG. 5); all figures show the same short recording. Real life recordings usually many more messages.

Besides simplifying the understanding of recordings, this kind of presentation is also closer to the specification in standards using message sequence charts, which may save a significant amount of time when validating implementations.

The invention is to visualize the recorded messages in the following way (FIG. 5). We assume the recorded messages are to be visualized in a certain area of a computer screen (a “window”), although the principle can also be applied to the whole screen or a sheet of paper produced by a printer. The area of the window is vertically split into two parts: a small strip at the top for labelling the entities concerned and a larger area below for visualizing the messages. The entities are visualized as e.g. a rectangle containing text in the strip plus a vertical line extending over the whole lower part of the window. The messages are visualized by a horizontal arrow starting at the entity sending the message to the entity receiving the message. The area containing arrows can be scrolled horizontally and vertically; when scrolled horizontally the strip containing the entities is synchronously with the area containing the arrows.

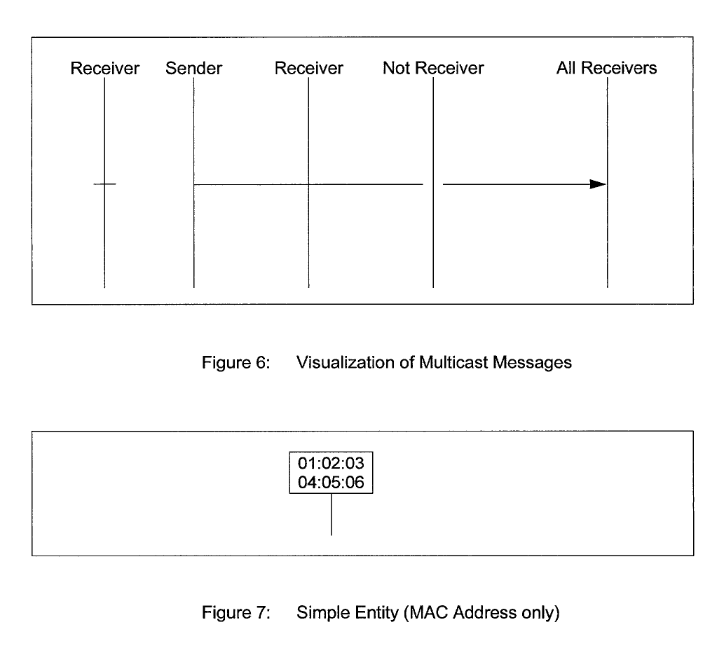

In case of messages sent from one entity to more than one other entity (multicast or broadcast), there could be an arrow from the entity sending the message to every entity receiving the message. A better solution appears to be to create a new entity of the screen that represents the set of the receivers of the message (as shown at the very right of FIG. 6) and to mark each receiver, for instance with a small horizontal line crossing the vertical line representing the receiver; this reduced the number of arrows draw and improves readability. See FIG. 6 for an example of a receiver outside the endpoints of an arrow (left), a sender (middle left), a receiver between the endpoints of an arrow (middle), an entity not receiving the message (middle right) and said new entity representing all receivers (right).

The arrows are labelled so that the user can easily identify the kind of message displayed.

The messages may also been drawn using different colors, for instance to identify the protocol, to which the messages belong.

The message sequence chart drawn in the window would usually require more space to be displayed than the window can provide. The window will therefore provide “scrollbars” that allows the content of the window to be scrolled horizontally or vertically.

The typical use of the message sequence chart is that the user analyzes the whole recording and, after finding messages of interest based on the limited information provided by the message sequence chart (the color and the label of the message), needs to see the whole content of a message. This can be accomplished by opening a separate window (or updating an area of the window reserved for that purpose) after the user moves the mouse pointer to a message of interest and pressing a button on the mouse. This would show the content of the message in the new window. The message of interest could be highlighted, e.g. by changing the background color of a stripe containing the messages. In addition to selecting a message using a mouse, the user could as well navigate through the message sequence chart by pressing certain keys on the keyboard. For instance the cursor keys could be used to highlight the next message, the previous message, the next or previous message received by the receiver or send by the sender of the presently highlighted message, and so on.

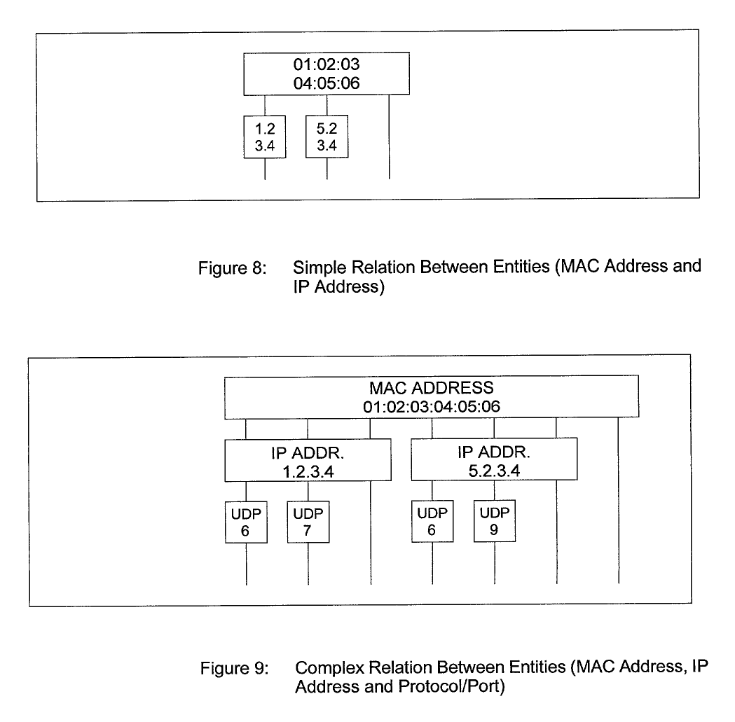

The entities that are sending or receiving messages may be related to other entities. Consider IP messages sent over an Ethernet to a router. These messages may have the same Ethernet (MAC) address for the router, but different IP addresses since they may address the router itself or some other machine toward which the router forwards the messages. The understanding of such relations, i.e. the router's MAC address represents several IP addresses, is essential for understanding the message sequence chart. Therefore, such relations should be visualized to the extent possible, for instance by representing the MAC address by a large rectangle on top of (or below) smaller rectangles that are all contained in the horizontal extent of the MAC address. This principle can be extended further to e.g. different port numbers used with the same IP address. Such structures usually require more space on the display, so the user should be able to control the granularity of the structure. An example for different levels of complexity between entities is shown in FIGS. 7, 8, and 9.

An implementation of this invention (i.e. a computer program) would start with an empty list of messages and entities. For every stored message it would check if the entities concerned (the sender and the receiver(s) are already in the entity list. If the sender or receiver (or group of receivers) is not in the list, the missing entities are inserted in the entity list. Then the message is added to the message list. The display (window) is updated accordingly. If the visualization is performed on-line, this causes the window to be updated after every message received. Often the user starts analyzing the stored message while the recording is still ongoing, causing the window to be updated frequently, which may disturb the user. Therefore a control, for instance a start and stop button like those of a tape recorder, should be provided in order to delay updates of the window (FIG. 5).

1. A method for displaying (visualizing) signalling messages in a graphical user interface of a network analyzer or capturing program, the method comprising: displaying single messages or groups of messages as horizontal arrows in a graphical user interface in such a way that all arrows starting (respectively ending) at a given horizontal position represent messages that have been sent (respectively received) by the same entity. The horizontal position thus identifies the sending (respectively receiving) entity; said horizontal position may in addition be represented by a vertical, and possibly labelled, line.

2. A method for displaying (visualizing) the structure of, or the relations between, sender(s) or receiver(s) of signalling messages in a graphical user interface, the method comprising: analyzing the address information (for instance MAC addresses, IP addresses, and port numbers) contained in the signalling messages, displaying one or several senders or receivers as one or more areas of the graphical user interface (typically located at the top of the graphical user interface) and a vertical line extending from said areas. The appearance of said area may be determined to some extent by the result of analyzing said signalling messages (for instance, showing address information obtained from the messages), and said vertical line being the vertical line menitioned in claim 1. The method may allow for determining the entities displayed from the messages alone, that is without the need to specify the entities beforehand.

3. A method for navigating between visualized messages, the method comprising: displaying more details of a signalling message in another area of the graphical user interface when the user selects the message (for instance by moving a mouse pointer close to the arrow and pressing a mouse button, or by using a keyboard for that purpose), and/or moving to the next message received or sent by a particular entity or group of entities when the user selects the entity or entities (for instance by moving a mouse pointer close to the said area occupied by the entity or entities or the vertical line extending from it) and using a mouse button or keyboard to indicate the direction (forward or backward) of the move, thereby scrolling parts of the graphical user interface if necessary.

4. The methods of claims 1, 2, or 3, using different colors for said arrows in order to distinguish between different kinds of signalling messages, or for said areas in order to distinguish between different kinds of senders or receivers.

5. The methods of claims 1, 2, or 3, labelling said arrows in order to distinguish between different kinds of messages, or labelling said areas in order to distinguish between different kinds of senders or receivers.

6. The methods of claims 1, 2, or 3, displaying (visualizing) groups of entities, such as receivers of a multicast or broadcast message, as another single entity representing that group.

7. The methods of claims 1, 2, or 3, displaying (visualizing) a group of entities as another entity and displaying (visualizing) messages received by that group as a single arrow drawn from the horizontal position representing the sender to the horizontal position representing the group in such a way that a user can easily identify which of the entities between the endpoints of the arrow receive the message and which do not.

8. The methods of claims 1, 2, or 3, using other graphical means than horizontal or nearly horizontal arrows, being characterized by using the horizontal extent of said graphical means to indicate which entities are related to the message represented by said graphical means.

9. The methods of claims 1, 2, or 3, using other graphical means than vertical lines to represent receivers or groups of receivers, including no graphical means at all (that is, omitting the vertical line and drawing said horizontal arrows only).

10. The methods of claims 1, 2, or 3, with the terms horizontal and vertical exchanged.

11. The methods of claims 1, 2, or 3, applied to other network protocols than the internet protocol (IP), in particular ITU's signalling system #7.

12. The methods of claims 1, 2, or 3, but using a printer, a data file, or another output device instead of a graphical user interface (computer screen) for visualizing signalling messages.
